(19) United States
(12) Patent Application Publication
(10) Pub. No.: US 2008/0056213 A1
(43) Pub. Date: Mar. 6, 2008

(54) MOBILE STATION, ACCESS POINT, AND METHOD FOR SETTING COMMUNICATION PARAMETERS

(75) Inventor: CHIEN-CHUNG KAO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/829,100

(22) Filed: Jul. 27, 2007

(30) Foreign Application Priority Data
Sep. 1, 2006 (CN) 200610062433.5

(51) Int. Cl. H04Q 7/24

(52) U.S. Cl. 370/338

(57) ABSTRACT

A method for setting communication parameters applied in a wireless local area network including a mobile station and an access point. The method includes: providing predefined communication parameters by the access point; transmitting a communication parameter setting request frame to the access point by the mobile station; determining whether the mobile station is a legal user by the access point; transmitting a communication parameter setting response frame from the access point to the mobile station if the mobile station is a legal user; establishing a secure channel between the access point and the mobile station; transmitting the predefined communication parameters to the mobile station via the secure channel by the access point; and setting communication parameters of the mobile station according to the predefined communication parameters by the mobile station.

### BACKGROUND

1. Field of the Invention

The present invention generally relates to wireless communications, and more particularly to a mobile station, an access point, and a method for setting communication parameters.

2. Related Arts

Wireless local area network (WLAN) devices, such as access points and mobile stations, communicate with each other according to the Institute of Electrical and Electronics Engineers (IEEE) 802.11 protocol. In a WLAN, a transmitting media is divided into plural channels for improving performance of the WLAN. In this situation, encryption techniques, such as wired equivalent privacy (WEP) technologies, are applied in the WLAN to ensure the data security of the WLAN. Therefore, network devices have to be set with communication parameters such as channel numbers, encrypted keys, and operating modes, before joining in the WLAN. Conventionally, operators manually set the communication parameters of the network devices, a task requiring very professional knowledge.

Therefore, a heretofore unaddressed need exists in the industry to overcome the aforementioned deficiencies and inadequacies.

### SUMMARY

In an exemplary embodiment, a mobile station adapted for communicating with an access point is applied in a wireless local area network. The mobile station includes a transmitting module, a receiving module, and a setting module. The transmitting module transmits a communication parameter setting request frame to the access point. The receiving module receives predefined communication parameters from the access point. The setting module sets communication parameters of the mobile station according to the predefined communication parameters.

The access point adapted for communicating with a mobile station includes a storage module, a receiving module, and a transmitting module. The storage module stores at least one predefined communication parameter. The receiving module receives a communication parameter setting request frame transmitted by the mobile station. The transmitting module transmits a communication parameter setting response frame and the predefined communication parameter to the mobile station according to the communication parameter setting request frame.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a block diagram of a mobile station in accordance with an exemplary embodiment of the invention;

FIG. 2 is a block diagram of an access point in accordance with the exemplary embodiment of the invention;

FIG. 3 is a schematic diagram of a communication parameter setting request frame in accordance with the exemplary embodiment of the invention; and

FIG. 4 is a flowchart of a method for setting communication parameters in accordance with another exemplary embodiment of the invention.

### DETAILED DESCRIPTION OF THE EMBODIMENTS

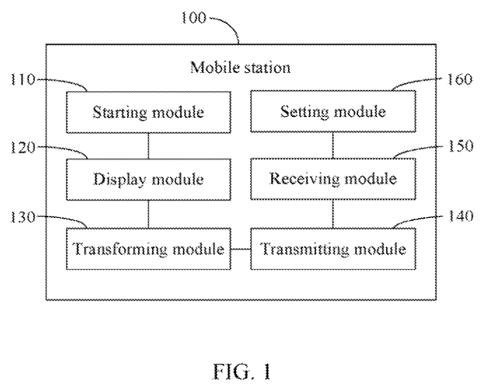

FIG. 1 is a block diagram of a mobile station 100 in accordance with an exemplary embodiment of the invention.

In this embodiment, the mobile station 100 is applied in a wireless local area network (WLAN). The mobile station 100 may be a laptop computer, a wireless fidelity (WiFi) phone, etc. The mobile station 100 includes a starting module 110, a display module 120, a transforming module 130, a transmitting module 140, a receiving module 150, and a setting module 160.

The starting module 110 is used for starting a communication parameter setting mode of the mobile station 100. In this embodiment, the mobile station 100 includes an input module such as a button (not shown). A communication parameter setting instruction is generated after the button has been pressed for a predetermined period of time such as 5 seconds. The starting module 110 starts the communication parameter setting mode of the mobile station 100 when the communication parameter setting instruction is generated.

The display module 120 indicates whether the mobile station 100 is in the communication parameter setting mode. The display module 120 includes a display device (not shown) and a display driver (not shown). The display device may be a light emitting diode (LED) or a liquid crystal display (LCD). In this embodiment, the display device is an LED. When the mobile station 100 is in a communicating mode, the LED is turned off by the display driver. When the mobile station 100 is in the communication parameter setting mode, the display driver turns on the LED.

The transforming module 130 performs Hash transformation on a media access control (MAC) address of the mobile station 100 creating a MAC address information packet.

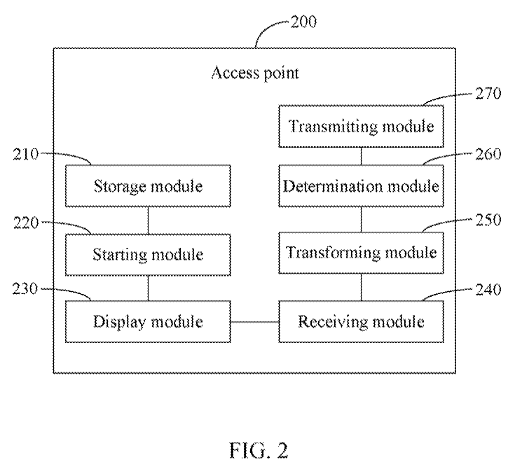

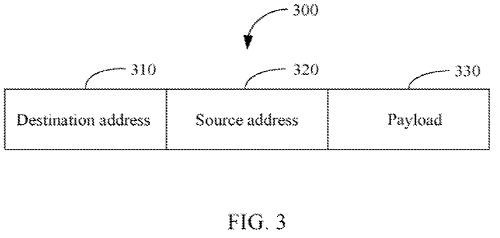

The transmitting module 140 transmits a communication parameter setting request frame 300 (as shown in FIG. 3, specified in the following) to an access point 200 (as shown in FIG. 2, specified in the following). In this embodiment, after the mobile station 100 turns to the communication parameter setting mode, the transmitting module 140 sends the communication parameter setting request frame 300 to the access point 200. The communication parameter setting request frame 300 is a management frame.

The receiving module 150 is used for receiving predefined communication parameters sent by the access point 200.

The setting module 160 is used for setting communication parameters of the mobile station 100 according to the predefined communication parameters sent by the access point 200. In this embodiment, the setting module 160 saves the service set identifier (SSID), the channel number, the encrypt key, and the operation mode in a memory of the mobile station 100. The mobile station 100 communicates with the access point 200 in a normal mode after setting the communication parameters.

FIG. 2 is a block diagram of an access point 200 in accordance with the exemplary embodiment of the invention.

In this embodiment, the access point 200 is applied in the WLAN. The mobile station 100 and the access point 200 communicate with each other according to the Institute of Electrical and Electronics Engineers (IEEE) 802.11 protocol. The access point 200 includes a storage module 210, a starting module 220, a display module 230, a receiving module 240, a transforming module 250, a determination module 260, and a transmitting module 270.

The storage module 210 stores the predefined communication parameters. In this embodiment, the predefined communication parameters are necessary communication parameters of the mobile station 100, which include a setting identifier code such as a service set identifier (SSID), a channel number, an encryption key such as a wired equivalent privacy (WEP) key, an operation mode, and so on.

The starting module 220 starts a communication parameter setting mode of the access point 200. In this embodiment, the access point 200 includes an input module such as a button (not shown). A communication parameter setting instruction is generated after the button has been pressed for a predetermined period of time such as 5 seconds. The starting module 220 starts the communication parameter setting mode of the access point 200 when the communication parameter setting instruction is generated.

The display module 230 indicates whether the access point 200 is in the communication parameter setting mode. The display module 230 includes a display device (not shown) and a display driver (not shown). The display device may be an LED or an LCD. In this embodiment, the display device is the LED. When the access point 200 is in the communicating mode, the display driver turns off the LED. When the access point 200 is in the communication parameter setting mode, the display driver turns on the LED.

The receiving module 240 receives the communication parameter setting request frame 300 sent by the mobile station 100.

The transforming module 250 performs Hash transformation on the MAC address of the mobile station 100 creating a MAC address information packet.

The determination module 260 determines whether the mobile station 100 is a legal user. In this embodiment, the determination module 260 determines whether the mobile station 100 is a legal user by comparing the Hash transformation results of a same message done by the transforming module 130 and the transforming module 250. If the transforming module 130 and the transforming module 250 perform Hash transformation on a same massage and get the same results, the determination module 260 determines that the mobile station 100 is a legal user. Otherwise, the mobile station 100 is an illegal user.

The transmitting module 270 transmits data to the mobile station 100. In this embodiment, the data sent by the transmitting module 270 includes communication parameter setting response frames and the predefined communication parameters.

FIG. 3 is a schematic diagram of the communication parameter setting request frame 300 in accordance with the exemplary embodiment of the invention.

In this embodiment, the communication parameter setting request frame 300 includes a destination address field 310, a source address field 320, and a payload field 330. The destination address field 310 includes the MAC address of the access point 200. The source address field 320 includes the MAC address of the mobile station 100. The payload field 330 includes a MAC address information packet of the mobile station 100.

In detail, the MAC address information packet is the result of the Hash transformation of the MAC address of the mobile station 100. After the access point 200 receives the communication parameter setting request frame 300, the transforming module 250 performs a Hash transformation of the source address of the communication parameter setting request frame 300, namely the MAC address of the mobile station 100. If the determination module 260 determines the Hash transformation result of the MAC address of the mobile station 100 is the same as the MAC address information packet, the mobile station 100 is a legal user.

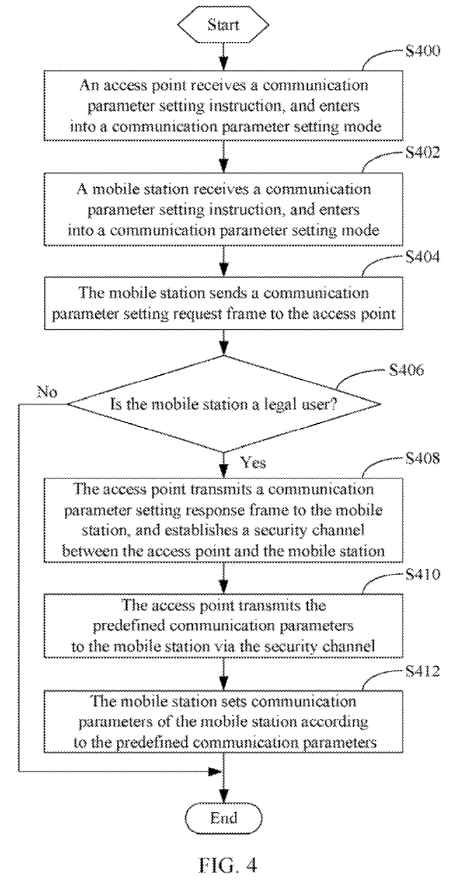

FIG. 4 is a flowchart of a method for setting communication parameters in accordance with another exemplary embodiment of the invention.

In step S400, the access point 200 receives a communication parameter setting instruction, and enters into a communication parameter setting mode.

In this embodiment, a button is configured in the access point 200, and the communication parameter setting instruction is generated after the button has been pressed for 5 seconds. After the access point 200 enters into the communication parameter setting mode, the driver of the display module 230 turns on the LED of the display module 230.

In step S402, the mobile station 100 receives a communication parameter setting instruction, and enters into a communication parameter setting mode.

In this embodiment, a button is configured in the mobile station 100, and the communication parameter setting instruction is generated after the button has been pressed for 5 seconds. After the mobile station 100 enters into the communication parameter setting mode, the driver of the display module 120 turns on the LED of the display module 120.

In step S404, the mobile station 100 sends the communication parameter setting request frame 300 to the access point 200.

In this embodiment, after the mobile station 100 and the access point 200 enter into the communication parameter setting mode, SSIDs of the mobile station 100 and the access point 200 are both set to a default character string “SAME-SSID”. Therefore, the mobile station 100 can send the communication parameter request frame 300 to the access point 200.

In step S406, the access point 200 determines whether the mobile station 100 is a legal user.

In this embodiment, the communication parameter setting request frame 300 sent by the mobile station 100 includes the MAC address information packet of the mobile station 100. The MAC address information packet is the result of the Hash transformation of the MAC address of the mobile station 100, and is stored in the payload field 330. After the access point 200 receives the communication parameter setting request frame 300, the transforming module 250 does Hash transformation of the source address stored in the source address field 320. The determination module 260 determines whether the Hash transformation result of the source address done by the access point 200 is the same as the MAC address information packet. If the results are the same, the mobile station 100 is a legal user, and step S408 is next. If the results are different, the mobile station 100 is an illegal user. In such case the access point 200 stops setting communication parameters for the mobile station 100.

In step S408, the access point 200 transmits a communication parameter setting response frame to the mobile station 100, and establishes a secure channel between the access point 200 and the mobile station 100.

In step S410, the access point 200 transmits the predefined communication parameters to the mobile station 100 via the secure channel.

In this embodiment, the predefined communication parameters are stored in the storage module 210. The predefined communication parameters include the SSID provided by the access point 200, the channel number, the encrypted key, and the operating mode. The SSID is different from the default SSID character string “SAME-SSID”, and can be changed by the access point 200 periodically, thereby improving the security of the wireless area network system.

In step S412, the mobile station 100 sets communication parameters of the mobile station 100 according to the predefined communication parameters.

In this embodiment, after the receiving module 150 receives the predefined communication parameters sent by the transmitting module 270, the setting module 160 saves the predefined communication parameters in a memory of the mobile station 100. Afterwards, the mobile station 100 can communicate with the access point 200 in a communicating mode. The driver of the display module 120 turns off the LED of the display module 120. Thus, the communication parameters of the mobile device 10 are automatically set.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A mobile station adapted for communicating with an access point in a wireless local area network, the mobile station comprising:
a transmitting module, for transmitting a communication parameter setting request frame to the access point;
a receiving module, for receiving predefined communication parameters from the access point; and
a setting module, for setting communication parameters of the mobile station according to the predefined communication parameters.

2. The mobile station as recited in claim 1, further comprising a starting module for starting a communication parameter setting mode of the mobile station.

3. The mobile station as recited in claim 2, further comprising a display module for indicating whether the mobile station is in the communication parameter setting mode.

4. The mobile station as recited in claim 3, further comprising a transforming module for performing Hash transformation.

5. The mobile station as recited in claim 1, wherein the communication parameter setting request frame is a management frame.

6. An access point adapted for communicating with a mobile station in a wireless local area network, the access point comprising:
a storage module, for storing at least one predefined communication parameter;
a receiving module, for receiving a communication parameter setting request frame transmitted by the mobile station; and
a transmitting module, for transmitting a communication parameter setting response frame and the predefined communication parameter to the mobile station according to the communication parameter setting request frame.

7. The access point as recited in claim 6, further comprising a starting module for starting a communication parameter setting mode of the access point.

8. The access point as recited in claim 7, further comprising a display module for indicating whether the access point is in the communication parameter setting mode.

9. The access point as recited in claim 8, further comprising a transforming module for performing Hash transformation.

10. The access point as recited in claim 9, further comprising a determination module for determining whether the mobile station is a legal user.

11. The access point as recited in claim 10, further comprising an establishing module for establishing a channel between the access point and the mobile station.

12. The access point as recited in claim 6, wherein the predefined communication parameters comprise an identifier code, a channel number, an encrypted key, and an operation mode.

13. A method for setting communication parameters applied in a wireless local area network comprising a mobile station and an access point, the method comprising:
providing predefined communication parameters by the access point;
transmitting a communication parameter setting request frame to the access point by the mobile station;
determining whether the mobile station is a legal user by the access point;
transmitting a communication parameter setting response frame from the access point to the mobile station if the mobile station is a legal user;
establishing a secure channel between the access point and the mobile station;
transmitting the predefined communication parameters to the mobile station via the secure channel by the access point; and
setting communication parameters of the mobile station according to the predefined communication parameters by the mobile station.

14. The method for setting communication parameters as recited in claim 13, further comprising:
the mobile station entering a communication parameter setting mode after receiving an instruction; and
the access point entering the communication parameter setting mode after receiving another instruction.

15. The method for setting communication parameters as recited in claim 13, wherein the access point and the mobile station have the same service set identifier (SSID) when the access point and the mobile station are in communication parameter setting modes.

16. The method for setting communication parameters as recited in claim 13, wherein determining whether the mobile station is a legal user comprises:
the access point and the mobile station respectively performing hash transformations on a same message; and
the access point determining that the mobile station is a legal user if same hash transformation results are obtained.
